(19) United States
(12) Patent Application Publication
(10) Pub. No.: US 2020/0189842 A1
(43) Pub. Date: Jun. 18, 2020

(54) Trash Receptacle Vent Tape

(71) Applicants: Kevin A. Haugan, Big Timber, MT (US); Tony J. Ballew, Livingston, MT (US)

(72) Inventors: Kevin A. Haugan, Big Timber, MT (US); Tony J. Ballew, Livingston, MT (US)

(21) Appl. No.: 16/221,482

(22) Filed: Dec. 15, 2018

(51) Int. Cl. B65F 1/06

(52) U.S. Cl. CPC B65F 1/068

(57) ABSTRACT

A thin, flexible polymer tape (10) with longitudinally formed grooves (12) allows a section of tape (10) to be creased into a substantially rigid profile having multiple mounting flanges (16). Pressure-sensitive adhesive (14) on the mounting flanges (16) provides a means for fastening the tape (10) to an interior surface of a trash receptacle (17) in specific fashion, thereby creating an air channel. The air channel allows atmospheric pressure to equalize the potential vacuum beneath receptacle liners due to upward pull on liners when removing them from the receptacle. The equalization of potential vacuum results in less tearing and reduced effort in removal of the liners. The tape's flat profile (11) before creasing allows it to be configured into a tightly rolled form (18), thus increasing shipment options, facilitating a more compact shipment of product, and minimizing the air volume in product shipments.

### CROSS-REFERENCE TO RELATED APPLICATIONS

This application claims the benefit of provisional patent application: Application Number 62679809 filed Jun. 2, 2018 by Kevin A. Haugan, Co-Inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to trash receptacles, specifically to vacuum alleviation vents for trash receptacles.

### BACKGROUND OF THE INVENTION—PRIOR ART

When lifting trash can liners from trash cans in order to empty them, negative results are often encountered. When filled, the liners are usually snug against the walls of the can and form a seal. Upon lifting, the seal creates a vacuum at the bottom of the can. When upward pull is increased to overcome the vacuum, the liner is often torn, leading to what is usually an unpleasant scenario. This vacuum also causes the cans to be lifted during trash removal, requiring one hand to lift a heavy liner and the other to secure the can. Besides inconvenience, this also creates an unnecessary difficulty frail or infirm individuals.

Several solutions have been proposed that allow atmospheric pressure to reach below the liner to equalize the vacuum. Some manufacturers have designed cans with built-in channels, which are often little more than open grooves. In certain scenarios where the liner extends into or blocks the groove, the benefit is negated. Other cans, as in U.S. Pat. No. 5,690,247 to Boover (1997), provide simple ports near the bottom of the can. This design, while alleviating vacuum, also allows vermin to enter the can and liquids to escape. U.S. Pat. No. 5,388,717 to LeVasseur (1995) also teaches ports near the bottom of the can, but places a grill over the apertures. Although keeping large animals from entering the can, the trash can liner rests against the grill, thus making the liner accessible to the claws and teeth of various animals. In addition, it does nothing to contain liquids in the can, and allows smaller insects to pass through the grill.

Some inventions in this field may be installed into cans having no prior provisions for venting. U.S. Pat. No. 6,015,063 to Poliquin (2000) is a molded device designed to hang from a can's rim and into a can. When lifting a full trash can liner from the can it is easily pulled out of the can along with the liner and dropped. Its rigid construction is also incapable of size compaction. U.S. Pat. No. 4,294,379 to Bard, (1981) teaches rigid conduits either molded into a can, or molded separately and then inserted into and adhered inside a trash can. Because Bard's conduit profile is tubular, its effective area is increased by the volume of air it surrounds. With its rigid shape, it is incapable of size compaction, so its shipping size is considerably larger than necessary. In addition, because its profile is closed, or tubular, its use of natural resources to manufacture in relation to planar or to semi-tubular channel profiles is greater than necessary.

### BACKGROUND OF THE INVENTION—OBJECTS AND ADVANTAGES—

Accordingly, several objects and advantages of the present invention are to provide a vacuum alleviation vent for trash cans
(a) which is readily used with cans having no prior provisions for venting;
(b) which does not compromise the integrity of cans against leaks and access by vermin;
(c) which is easily adjusted for various can heights;
(d) which is resistant to blockage;
(e) which is securely affixed to the can;
(f) which simplifies the manufacturing process;
(g) which minimizes the use of natural resources to manufacture;
(h) which minimizes shipping size and expense; and
(g) which may be compacted into a tightly rolled form allowing reduction in shipments of air.

### SUMMARY

In accordance with the present invention a vent tape comprises a flat, elongated body having a plurality of longitudinal grooves, a plurality of regions on which pressure-sensitive adhesive has been applied; and a plurality of non-stick strips with which to cover the regions of pressure-sensitive adhesive in order to prevent premature adhesion.

### DRAWINGS—FIGURES

In the drawings, closely related figures have the same number but different alphabetic suffixes.

FIG. 1A—Preferred vent tape embodiment, four-groove profile.

FIG. 1B—Preferred vent tape, four-groove profile, formed, ready for application.

FIG. 1C—Preferred vent tape applied to trash can.

FIG. 2—Preferred vent tape in rolled configuration.

FIG. 3—Rolls of vent tape in an alternate shipping configuration around roll of trash can liners.

FIG. 4A—Alternate vent tape with three-groove profile.

FIG. 4B—Alternate vent tape, three-groove profile, formed, ready for application.

FIG. 4C—Alternate three-groove tape, formed, applied to trash can.

FIG. 5A—Alternate embodiment vent tape, two-groove profile, formed

FIG. 5B—Alternate two-groove tape, applied to trash can.

FIG. 6A—Two-groove tape with curved profile

FIG. 6B—Two-groove tape with curved profile, mounting flanges formed, ready to apply

FIG. 7A—Alternate vent tape with no grooves

FIG. 7B—Alternate tape with no grooves, applied to can corner

### DRAWINGS—REFERENCE NUMERALS

10 Vent tape, preferred embodiment
11 Vent tape's flat profile before creasing
12 Groove
13 Outermost edges of vent tape
14 Pressure-sensitive Adhesive
15 Non-stick backing for adhesive
17 Trash can
18 Preferred embodiment, rolled configuration
19 Roll of trash can liners
20 Alternate tape, three-groove embodiment
30 Alternate tape, two-groove embodiment
40 Alternate tape, curved profile

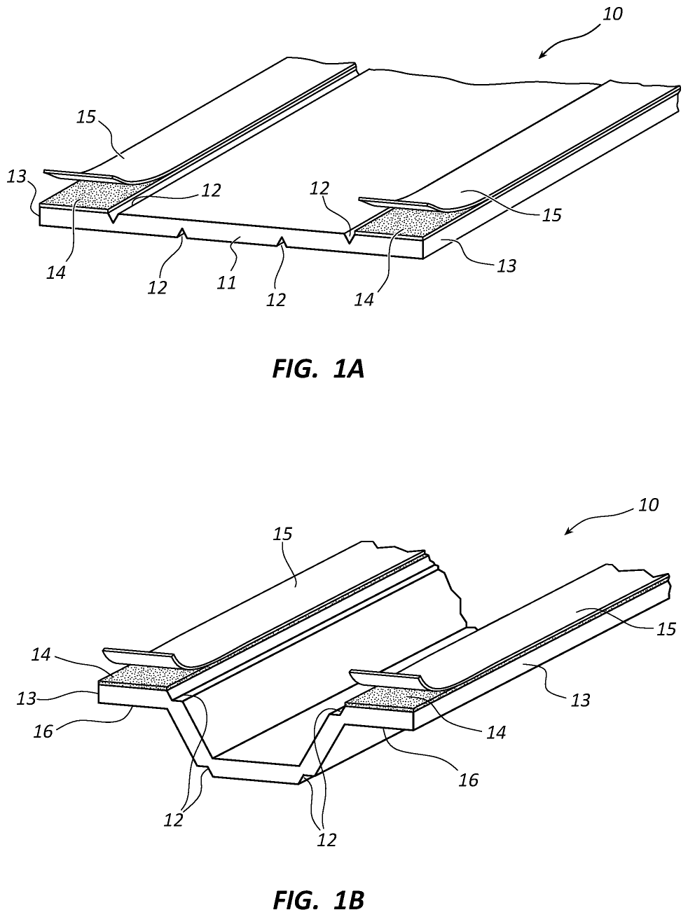

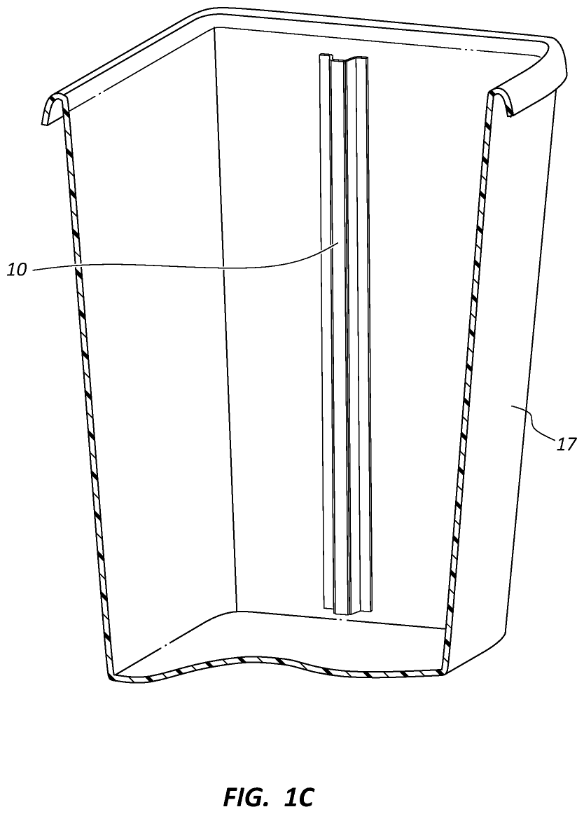

### DETAILED DESCRIPTION—PREFERRED EMBODIMENT—FIGS. 1A, 1B, 1C

A ribbon of polymeric material, or tape 10 having a planar, or flat profile 11 as viewed if FIG. 1A, has four longitudinal hinge members, or grooves 12, two on one side of tape 10, and two on the other side, as shown. Grooves 12 are positioned so that tape 10 may be creased into a profile similar to that of FIG. 1B, thus creating two mounting flanges 16. Pressure-sensitive adhesive 14 is applied longitudinally to flanges 16 on the same side of tape 10 as the grooves which are nearest to outermost edges 13, as shown. A removable, non-stick backing 15 covers adhesive 14 to prevent premature adhesion.

### Operation—Preferred Embodiment—FIGS. 1A, 1B, 1C, 2, 3

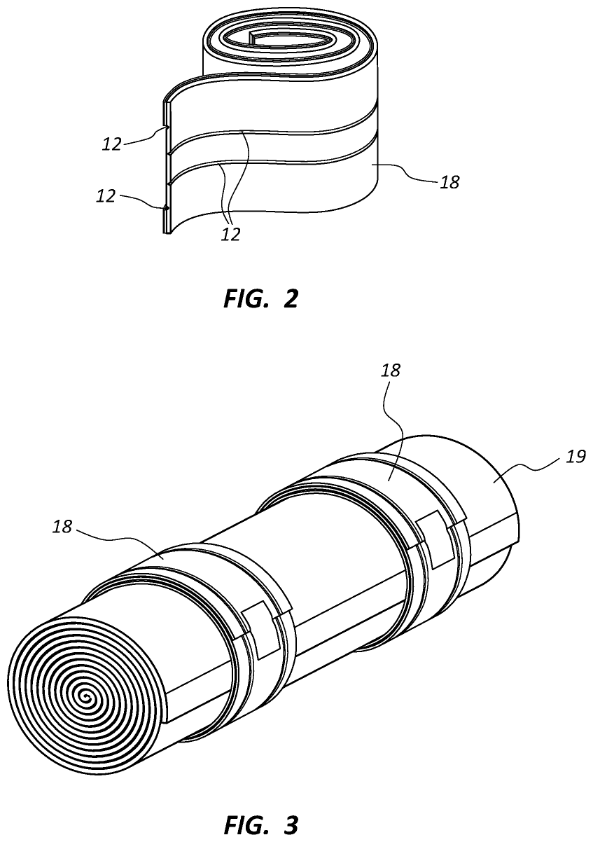

A section of vent tape 10 is first unrolled from roll 18 (FIGS. 2,3). Tape 10 is then cut to a predetermined length, typically, slightly less than the depth of trash can 17 (FIG. 1C) to be vented. In FIG. 1B, tape 10 is shown creased longitudinally opposite each groove 12 in such fashion that an angle is formed at each groove, resulting in approximate profile as shown.

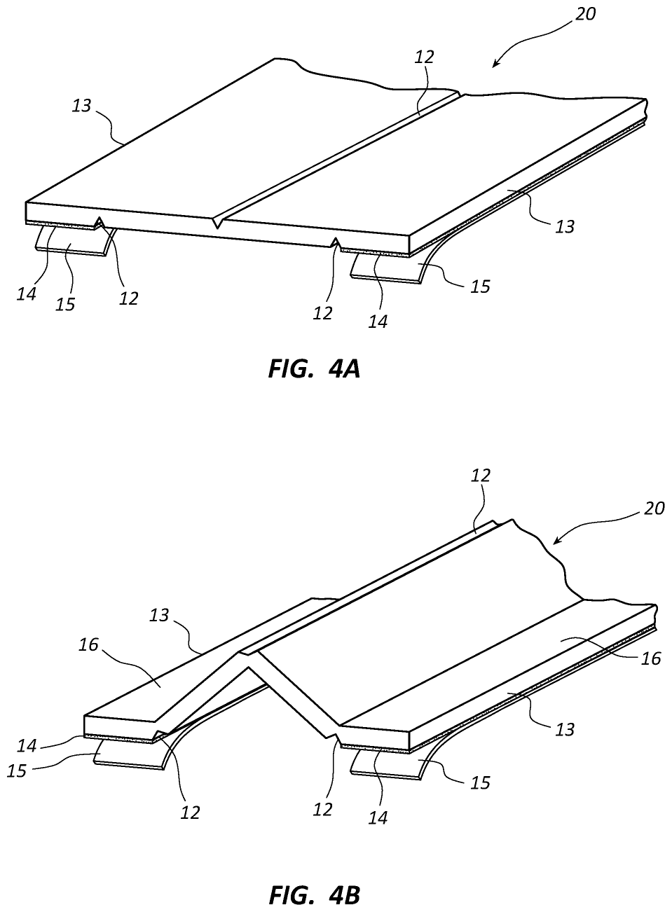

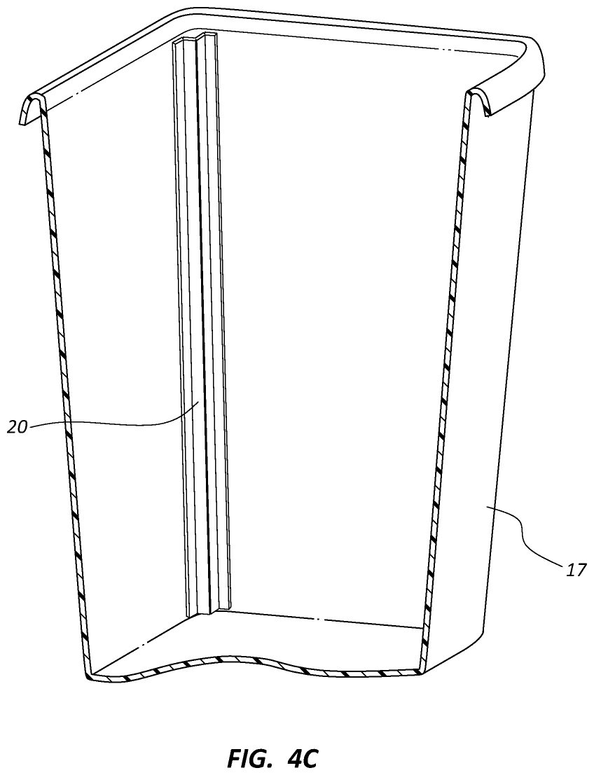

In FIG. 1C, tape 10 has been formed and the non-stick backing 15 removed from adhesive 14. The formed section of vent tape 10 is applied in vertical orientation to the inside of can 17, as shown. By adjusting the angle of the mounting flanges, Tape 10 may also be positioned in can corners in similar fashion to that shown in FIG. 4C.

### Description—Alternative Three-Groove Embodiment—FIGS. 4A, 4B

Vent tape 20 is identical in construction to the preferred embodiment tape 10, except that it has three longitudinal grooves, two on one side and one groove in the center of the opposite side as shown, so that tape 20 may be creased into a profile similar to that of FIG. 4B.

### Operation—Alternative Three-Groove Embodiment—FIGS. 4A, 4B, 4C, 1C

Alternative embodiment vent tape 20 is cut, formed, and applied in identical fashion as the preferred embodiment tape 10. FIG. 4B shows the approximate finished shape of the alternative embodiment. By adjusting the angle of the mounting flanges, the tape may be applied to can corner, as in FIG. 4C, or to can side, similar to FIG. 1C.

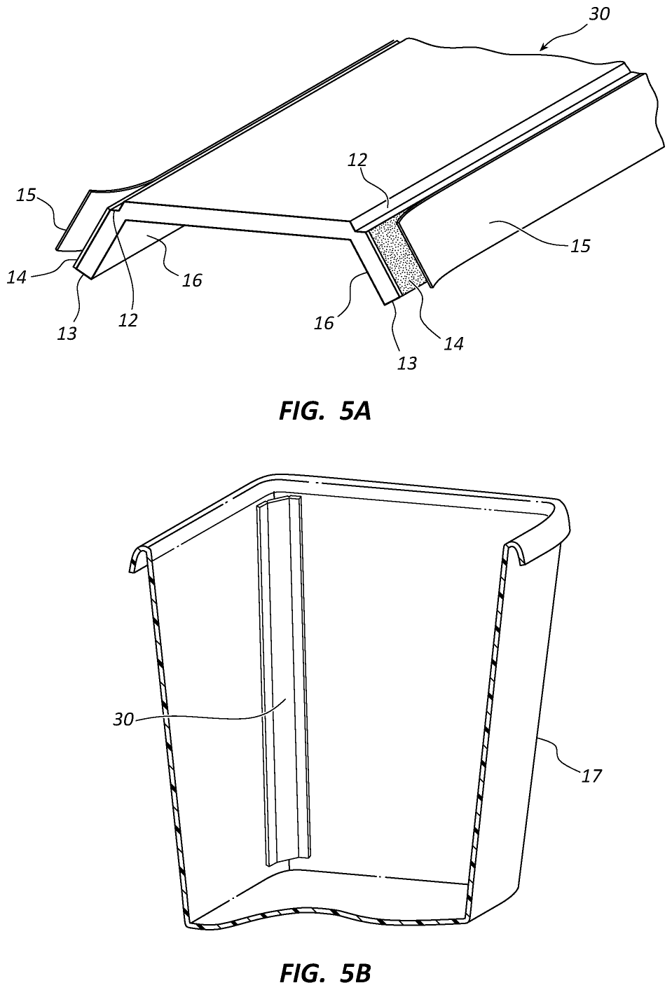

### Description—Alternative Two-Groove Embodiment—FIG. 5A

Vent tape 30 is identical in construction to the preferred tape 10, except that it has two grooves on one side of tape 30, as shown, so that it may be creased into a profile approximating that of FIG. 5A.

### Operation—Alternative Two-Groove Embodiment—FIGS. 5A, 5B

Tape 30 is cut, formed, and applied in identical fashion as the preferred tape 10. FIG. 5A shows the approximate shape of tape 30 after creasing. FIG. 5B shows tape 30 mounted in a can corner.

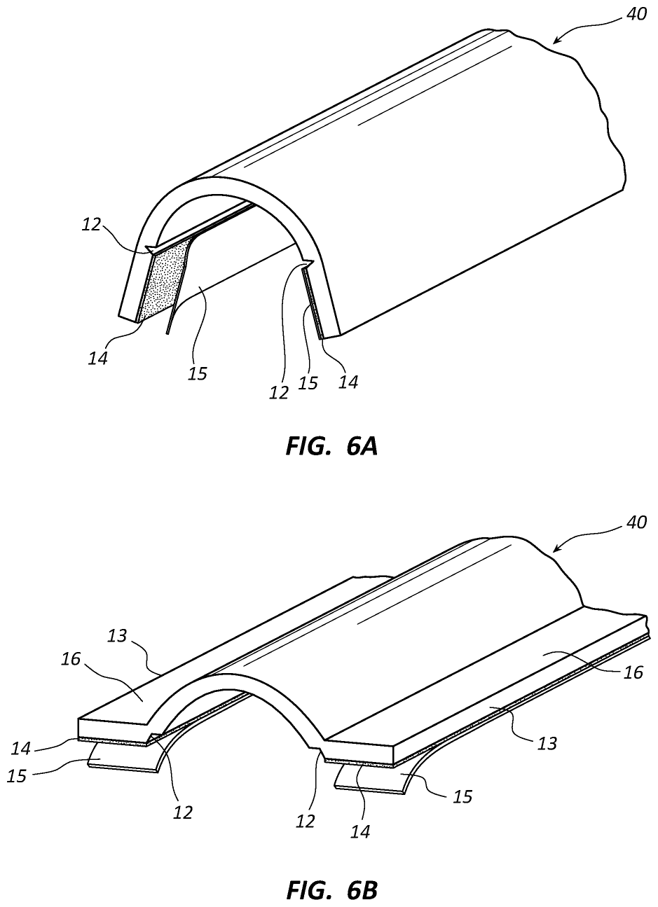

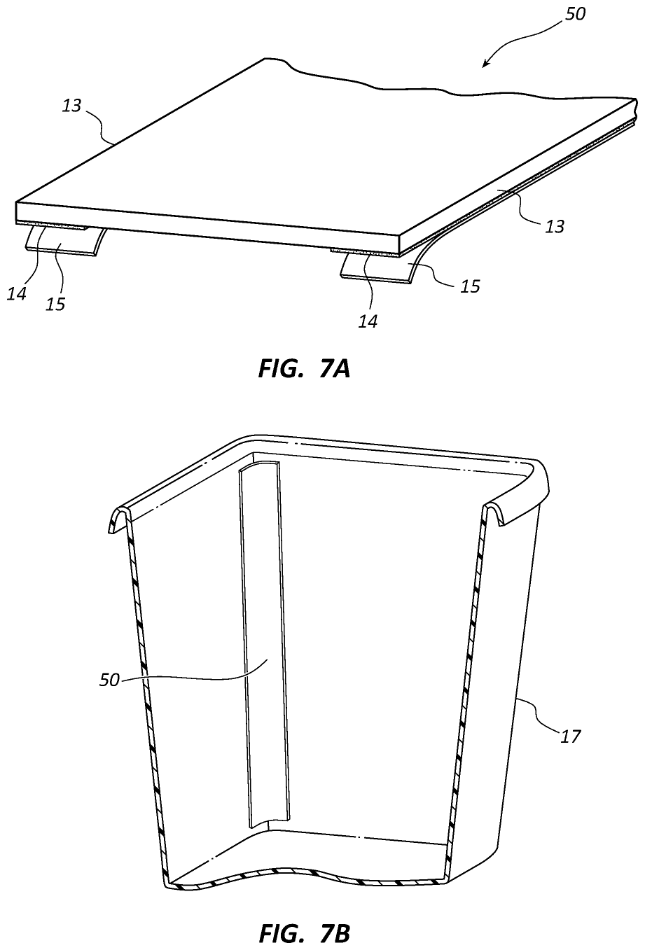

### Additional Embodiments—FIGS. 6A, 6B, 7A, 7B

FIGS. 6A and 6B present a curved tape 40, which may also be configured into a rolled form 18, similar to FIG. 2, and whose curved profile may, in some cases, prove beneficial. Also, FIGS. 7A and 7B show the profile and application of a vent tape 50 with no grooves. For some receptacle shapes including those with short-radius or 90° corners, tape 50 may be desired. Additionally, for receptacle styles having built-in channels, tape 50 may be used to eliminate blockage of the channels and to protect their integrity.

### Ramifications and Scope—

Thus, the reader will see that the vacuum alleviation vent of the present invention provides an efficient, lightweight, and economical device that is easily applied to trash receptacles having no prior venting provisions. Additionally, our vent reduces the use of natural resources, and may be configured into a compact form that minimizes shipping space requirements and maximizes shipping options.

While our above description contains many specificities, these should not be construed as limitations on the scope of the invention, but rather as an exemplification of one preferred embodiment thereof. Many other variations are possible. For example, materials other than polymeric may be used for all tape embodiments if desired results are attainable. Also, a specific number of hinge members, or grooves is used in the above embodiments to obtain the desired shapes of tapes 10, 20, 30 and 40. Any number and position of longitudinal grooves and the resultant configurable shapes is possible.

Additionally, the hinge motion required to attain the desired profile of the above embodiments is facilitated, as noted, by longitudinal grooves 12. Longitudinal scores, perforations, or means other than grooves 12 may be used.

Accordingly, the scope of the invention should be determined not by the embodiments illustrated, but by the appended claims and their legal equivalents.

What is claimed is:

1. A vacuum alleviation vent tape for trash receptacles comprising
(a) a flat, elongated ribbon constructed of substantially flexible material;
(b) a plurality of hinge members longitudinally formed into a surface of said ribbon, said hinge members being positioned in predetermined locations and of a predetermined quantity that facilitate said ribbon to be creased so as to form a profile of predetermined shape;
(c) pressure-sensitive adhesive located between outermost edges of said ribbon and said hinge members nearest said outermost edges; and
(d) removable, non-stick backing material of sufficient size to cover said pressure-sensitive adhesive;
whereby an economically manufactured, readily-configurable, and easily-applied vacuum alleviation vent for trash receptacles may be substantially condensed into a tightly rolled form thereby increasing shipping efficiency and multiplying shipping options.

2. The vent tape of claim 1 wherein said substantially flexible material is polymer-based.

3. The vent tape of claim 1 wherein said hinge members are grooves.

4. The vent tape of claim 1 wherein said hinge members are scores.

5. The vent tape of claim 1 wherein said hinge members are perforations.

6. The vent tape of claim 1 wherein said predetermined quantity of said hinge members is four.

7. The vent tape of claim 1 wherein said predetermined quantity of said hinge members is three.

8. The vent tape of claim 1 wherein said predetermined quantity of said hinge members is two.

9. The vent tape of claim 1 wherein said profile of a predetermined shape comprises a plurality of mounting flanges.
